(19) United States
(12) Patent Application Publication
(10) Pub. No.: US 2025/0073932 A1
(43) Pub. Date: Mar. 6, 2025

(54) CONTACTLESS SAFEGUARDING AT A COOPERATION ZONE OF A MACHINE

(71) Applicant: SICK AG, Waldkirch (DE)

(72) Inventors: Christoph HOFMANN, Waldkirch (DE); Peter POKRANDT, Waldkirch (DE)

(21) Appl. No.: 18/817,940

(22) Filed: Aug. 28, 2024

(30) Foreign Application Priority Data
Aug. 29, 2023 (EP) 23194104

(51) Int. Cl. B25J 19/06; B25J 9/16

(52) U.S. Cl. CPC B25J 19/06; B25J 9/1676; B25J 9/1697

(57) ABSTRACT

A method for a contactless safeguarding at a cooperation zone of a machine is provided wherein an access zone for a worker is arranged at a first side of the cooperation zone and a working zone of the machine is arranged at a second side, wherein a plurality of protected fields configured in the environment of the cooperation zone are monitored for protected field intrusions by at least one optoelectronic sensor and at least two of the protected fields 38) are arranged in a first sequence starting from the first side such that a worker sequentially intrudes into these protected fields when approaching the cooperation zone, and wherein the protected field intrusions are evaluated to safeguard the machine in the case of an unpermitted combination of protected field intrusions. In this respect, at least two of the protected fields are arranged in a second sequence starting from the second side such that the machine sequentially intrudes in these protected fields when approaching the cooperation zone.

The invention relates to a method and to a monitoring device for a contactless safeguarding at a cooperation zone of a machine respectively.

Optoelectronic sensors are very frequently used having protected field monitoring in contactless monitoring for safeguarding hazards such as are represented by machines in an industrial environment. A protected field is a configured partial zone of the monitored zone that may not be entered by operators during the operation of the machine. If an unauthorized protected field intrusion is recognized, for instance a leg of an operator, the machine is switched to a safe state by outputting a safety related signal at a safe output (OSSD, output signal switching device).

Sensors used in safety technology have to work particularly reliably and must therefore satisfy high safety demands, for example the EN13849 standard for safety of machinery and the machinery standard EN61496 for electrosensitive protective equipment (ESPE). To satisfy these safety standards, a series of measures have to be taken such as a safe electronic evaluation by redundant, diverse electronics or different functional monitoring processes, especially the monitoring of the contamination of optical components, including a front lens. Safety levels, for example SIL1 to SIL4 (safety levels) or PLA to PLD (performance levels) are defined for such safe sensors or for the safety applications implemented therewith.

For safeguarding, the machine is blockaded by construction means in part, for instance with fences, and is safeguarded by sensors in a remaining access zone. There is a particular challenge if access to the safeguarded machine is repeatedly required in regular operation. Examples include robot cells in which industrial robots take over production steps or logistics steps that have to be supported at points. It is here, for example, the supply or collection of material. In practice, such zones are still safeguarded as a rule by fences and light grids. A person who enters the zone of the machine is recognized and the machine is thereupon switched off. Once the supporting worksteps on the machine have been completed and the machine zone has been left, a manual restart is required in that, for example, the person actuates a button attached outside the safeguarded zone. This is necessary because the sensors cannot safety detect whether the person has actually left again. A light grid only recognizes the passing through itself, but cannot decide the side on which the person is subsequently located. The protected field of a laser scanner cannot always cover the entire zone in front of the machine, for example because otherwise the machine would trigger the protected field in operation. In addition, the person could climb onto a fixed objects such as a stand of the machine and could thus become invisible to the laser scanner. Conventionally, a person must therefore be responsible for the machine not endangering anyone on the restart.

Safety laser scanners and safety cameras have become known in more recent times that simultaneously evaluate a plurality of protected fields. In this respect, the simultaneous evaluation is very calculation intensive and only a limited number of parallel protected fields is provided. A plurality of protected fields also do not per se solve the described problems; the flexibility provided thereby is not even used in most existing safeguarding applications and their potential is anyway by no means made full use of.

EP 3 470 879 A1 configures at least partially mutually overlapping monitored fields in a laser scanner. Monitored segments are thereby produced that differ from one another by which monitored fields overlap there. The number of monitored fields provided at the hardware side is thus refined to the monitored segments. A larger number of possible protected fields is thus effectively provided that are, however, not thereby automatically configured as intelligent.

EP 3 709 106 A1 proposes a safety system that validates complex, unsafe evaluations by fewer complex safe evaluations. In an embodiment, objects are, on the one hand, localized in an unsafe manner using scan point clouds. On the other hand, there is a grid of protected fields. The unsafely determined fine position is validated by the safe grid position.

EP 3 153 885 A1 discloses a piece of optoelectronic protective equipment that monitors which of a plurality of protected zones has been infringed by an object (protected zone infringement) and which protected zone the object has left (protected zone release). The plant operation is automatically released on a predetermined order of protected zone infringements and protected zone releases.

A device for safeguarding a hazardous zone of a plant is presented in EP 3 575 666 A1 that monitors a protected zone adapted to the hazardous zone. The movement routine of the object on the departure from the protected zone is detected and, on registration of a valid movement routine, a release signal is generated that activates the hazardous operation of the plant again.

The still unpublished European patent application bearing the file reference 23162023.8 monitors the zone in front of the machine using protected fields in a lower location and in an upper location to thus distinguish an approaching person from a vehicle.

Against this background, it is the object of the invention to improve the safeguarding at a cooperation zone of a machine.

This object is satisfied respectively by a method and by a monitoring device for a contactless safeguarding of a machine. The machine is preferably at least one robot. A zone is called a cooperation zone that workers and the machine use together, for instance to transfer a workpiece or material in the one direction or the other, to carry out a manual assembly step or one assisted by the machine, and the like. However, this common access may not take place simultaneously during a machine movement since otherwise an unwanted contact or accident may occur and preventing this is the purpose of the safeguarding.

The cooperation zone is reachable from a first side via an access zone for the worker and from a second side for the machine from its working zone. The first side is preferably disposed opposite the second side; the machine is then behind the cooperation zone from the viewpoint of the worker. The working zone is otherwise preferably closed, i.e. mechanically secured via fences and the like, with there being able to be further access zones in particular likewise safeguarded in accordance with the invention. An example is a closed robot cell as a working zone.

A plurality of protected fields are monitored for protected field intrusions in the environment of the cooperation zone by at least one optoelectronic sensor. The protected fields are each per se configurable partial zones of the detection zone of the sensor and bear the historically determined name of protected field even though it may in reality be a three-dimensional spatial zone depending on the sensor type. At least two of the protected fields are arranged in a first sequence starting from the first side. A worker approaching the cooperation zone therefore sequentially triggers protected field intrusions in these protected fields. Unlike a conventional protected field, a protected field intrusion by no means immediately triggers a safeguarding. There are rather permitted and unpermitted combinations of protected field intrusions and the machine is only safeguarded in the case of an unpermitted combination.

The invention starts from the basic idea of complementing the sequential monitoring on the worker side with a sequential monitoring on the machine side. At least two of the protected fields are therefore arranged in a second sequence starting from the second side so that the machine approaching the cooperation zone sequentially triggers protected field intrusions in the second sequence. It follows from geometrical considerations alone that the protected fields of the two sequences are different protected fields, i.e. the protected fields of the first sequence on the worker side have to be distinguished from the protected fields of the second sequence on the machine side. The two sequences meet at the cooperation zone; a protected field can exceptionally belong to both sequences in a dual function here. The evaluation for permitted and unpermitted combinations of protected field intrusions now includes the second sequence. Whether an approach of a worker is therefore permitted with a continued operation of the machine or whether the machine has to be safeguarded depends on both the worker and the machine.

The machine can in principle intrude into the first sequence beyond the cooperation zone from its second side; this does not yet per se mean an unpermitted combination of protected field intrusions, but can naturally be directly prohibited as an unpermitted combination. Conversely, this generally also applies to the worker and his intrusions into protected fields of the second sequence. This is, however, preferably prohibited and thus ensures trespass protection. The principle is proven overall that the worker and the machine advantageously always remain on their sides in operation of the machine even if the invention would be able to nevertheless provide safety under defined conditions.

The at least one optoelectronic sensor is preferably a safe sensor that accordingly performs safe protected field monitoring. Safe and safety mean, as in the total description, that measures are taken to control errors up to a specific safety level or to observe regulations of a relevant safety standard for machine safety or for electrosensitive protective equipment, of which some have been named in the introduction. Unsafe is the opposite of safe and accordingly said demands on failsafeness are not satisfied for unsafe devices, transmission paths, evaluations, and the like.

The method is a computer implemented method that runs, for example, in a processing unit of the optoelectronic sensor and/or a connected processing unit. The configuration of the protected fields is preceded by the contactless safeguarding; it typically takes place manually by a safety expert due to the complex safety aspects to be observed. In this respect, however, automatic aids are possible such as proposals for protected fields and a configuration program having graphical support, similar to a CAD program, for example, by which geometrical objects as parts of protected fields can be fit into images of the environment of the machine.

The invention has the advantage that collaborative safety can be provided using comparatively simple means. The protected fields can even be set up by only one single optoelectronic sensor. To gain additional perspectives or to achieve a higher safety level through redundancy, two or more sensors can preferably be used. This is in any case substantially less than an arrangement of a large number of light grids often conventionally still required.

Costs and construction space are thus saved; for example, a robot cell can be set up more compactly thanks to the intelligent safeguarding in accordance with the invention and further productivity advantages and cost advantages are associated therewith. The safeguarding of the access to the cooperation zone can additionally act as trespass protection and can support an automatic restart. A deceleration or even a stopping of the machine only takes place when really necessary.

The optoelectronic sensor is preferably a 3D sensor, in particular a time of flight camera, with the protected fields being three-dimensional protected fields. Great flexibility in configuring protected fields, and sequences of protected fields thus results that effectively safeguard the environment of the cooperation zone. These protected fields are three-dimensional spatial zones and thus enable a yet more gap-free monitoring that can be adapted better. In this respect, the historical term of protected field is maintained despite the spatial extent. The first safe optoelectronic sensor can alternatively be a laser scanner. The 3D camera can, however, be assembled more simply in a suitable perspective in which the matching protected fields can be monitored. A further alternative is an FMCW sensor that can even be understood as being even dimensionally higher than a 3D sensor due to an additional determination of speed components, but can thus in particular be understood as a 3D sensor.

At least two optoelectronic sensor preferably each monitor some of the protected fields, with at least one protected field being monitored by both optoelectronic sensors and therefore being monitored at an elevated safety level. Additional perspectives, in total greater monitoring processes, and a larger number of monitored protected fields are possible using a plurality of sensor. Exactly two sensors are particularly preferably already sufficient for this, in particular when they are 3D cameras. A further advantage is the possibility of a redundant monitoring of protected fields in overlap zones of two sensors. A higher safety level can thereby be achieved. Two sensors that per se only have a PLc (performance level in accordance with ISO TS 62998) can even reach PLd in combination. This is also interesting because it means a huge effect to bring a device to a higher safety level and because it can also only be done by the manufacturer in a complex and/or expensive development process. A combination of sensors, is, in contrast, possible on the part of the user using available hardware.

A protected field preferably comprises the cooperation zone. The central zone to which the worker and the machine have access in accordance with the intended purpose is thus itself safeguarded. This protected field is particularly preferably monitored by both optoelectronic sensors. A higher safety level is thereby even achieved, in particular locally related to zones monitored in an overlapping manner. There can be further protected fields with redundant monitoring and thus a higher safety level, in particular for protected fields that are directly adjacent to the protected field of the cooperation zone.

It is preferably considered a permitted combination of protected field intrusions when protected fields of the first sequence and/or of the second sequence are infringed sequentially from the outside to the inside, with inside designating the cooperation hone, but with a minimum number of protected fields without a protected field intrusion remaining between protected fields of the two sequences. The expectation on a proper running is therefore that the worker and the machine approach the cooperation zone from their respective sides. A sequence of protected field intrusions can to this extent also be enforced in a construction aspect and by the configuration of the protected fields. It is demanded as further conditions that a minimum number of protected fields without a protected field intrusion remains between the worker and the machine. It is here not a question only of a minimum distance that is naturally thus implicitly enforced. Without the minimum number, it would rather no longer be possible to distinguish whether the worker and the machine would possibly meet, as will also be explained in more detail in the following. The minimum number can be understood as a buffer of free protected fields between the worker and the machine.

When a protected field of the first sequence is infringed, the machine may preferably no longer intrude into a protected field associated with the protected field of the first sequence corresponding to the minimum number and the machine withdraws therefrom provided that it already intrudes into the associated protected field. Certain protected fields are therefore prohibited on an approach of the worker in which it could intrude in the absence of the worker, but that are too close to the worker now recognized in the protected field. This has the result that the minimum number of protected fields without a protected field intrusion between the worker and the machine is still observed or is reestablished. The prohibition of intruding into the associated protected field is an instruction to the machine controller as is the optionally required retreat therefrom. The machine controller itself is preferably not safe in order here to avoid the effort for safety that meets the standard. It is safely recognized by the protected field monitoring whether the machine controller follows the instruction so that a response can be made in the event of an error by a repeat instruction to the machine controller or if required a safeguarding of the machine. The determination which protected field is the respective associated protected field is manually determined using the protected field configuration when setting up the safety application, for example in the form of a finite state machine presented further below or, for example, the nth neighbor within the sequences is associated, in particular with n equal to the minimum number plus or minus a constant.

When observing a first minimum number preferably the first minimum number equal to two, the machine preferably works without any restriction of its work speed. The buffer of free protected fields is large enough in this case that there is still no impending danger. Even with a further mutual approach with an additional protected field intrusion of the worker or of the machine, there would still be a free protected field between the worker and the machine. Where the worker and the machine are located would then still be able to be distinguished.

When observing only a second minimum number smaller than the first minimum number, preferably the second minimum number equal to one, the worker preferably receives a warning to not further approach the cooperation zone. The buffer of free protected field zones has now become too small; it no longer contains sufficient reserves. In this situation, as explained above, the machine has preferably received the instruction to withdraw from a protected field to reestablish a larger buffer. The worker should, however, remain careful and not approach further to give the machine sufficient time for the withdrawal. The warning takes place, for example, in the form of a display, a color of a lamp, and/or an acoustic signal. However, safeguarding preferably does not yet take place; the machine can continue to work, preferably as soon as the minimum number has been reestablished.

The machine is preferably safeguarded when a minimum number has not been observed. The smallest minimum number is meant here to the extent that there are staggered minimum numbers as in the previous paragraphs. There are in particular no longer any buffers; the protected fields in which there is an intrusion on the worker side are directly adjacent to the protected fields in which there is an intrusion on the machine side. It is no longer possible to distinguish in this situation whether the worker and machine still dwell in adjacent protected fields or whether they can already come into contact in the same protected field; safeguarding is therefore no longer avoidable. Safeguarding means an appropriate response that precludes an accident. It can be a deceleration of the machine, a withdrawal, or an immediate stopping or moving into a safe state. In accordance with the standard ISO 10218-1 categories of stops can be distinguished. A stop of category 2 permits the power supply of the machine not to be interrupted. Only stop categories 0 and 1 can be used as emergency stops. The mildest form of safeguarding that still ensures safety is preferably always selected. The automatic restart with a stop of category 2 discussed in the following paragraph is possible, for example, but not after an emergency stop.

The machine preferably restarts automatically as soon as the minimum number has been reestablished or a protected field is no longer infringed. The machine takes up its work again on its own when there is again a sufficient buffer of free protected fields between the worker and the machine. As a precaution, the automatic restart can be linked to the stricter condition that all the protected field intrusions have been canceled in the meantime. It is conceivable to provide an independent trespass protection, for instance an additional safe radar or a further optoelectronic sensor. It is thus prevented that a person has entered the working zone and has not left is again in an unnoticed manner during the safeguarding.

For the evaluation of the protected field intrusions and the measures therefore to be taken with respect to the machine, a finite state machine is preferably used whose transitions are determined by an additional intrusion into a protected field of a sequence or the ending of an intrusion into a protected field of a sequence is determined, wherein the measures are a moving of the machine away from the cooperation zone in the second direction, a prohibition of intrusions into a protected field by the machine, and/or the canceling of a prohibition of intrusions into a protected field. Additional intrusions or the ending of intrusions could equally be called approach movements or retreating movements of the worker or machine. The respective states are associated with instructions to the machine and, where necessary, its safeguarding. Such instructions have the result that the machine observes a greater distance from the cooperation zone or initially establishes it by an active withdrawal due to the prohibition of intrusions into protected fields. Conversely, such prohibitions can be canceled in states in which the workers is sufficiently far away from the cooperation zone.

The first sequence preferably comprises, from the outside to the inside with respect to the cooperation zone, a first protected field α, a second protected field β, and a third protected field γ, the cooperation zone is monitored by a fourth protected field δ and the second sequence comprises, from the inside to the outside of the cooperation zone, a fifth protected field ε and a sixth protected field ζ. This is an advantageous protected field configuration in a weighing of sufficient safeguarding and flexibility without any unnecessary complexity by a high number of protected fields.

Two optoelectronic sensors preferably monitor five protected fields W, A, B, C, D, namely the one optoelectronic sensor in the access zone monitors an outer first protected field W, a second protected field A enclosing the zone between the first protected field W and the cooperation zone, and a fourth protected field C adjoining in the working zone and comprising the cooperation zone and the other optoelectronic sensor in the working zone monitors an outer fifth protected field D and adjoining it a third protected field B comprising the cooperation zone and projecting into the access zone. This is an advantageous configuration in which two sensors participate that each manage with very few protected fields. The protected field W can only be a warning field and not yet a protected field. This is in particular useful when the sensor can only monitor a limited number of protected fields. A warning field is here preferably subsumed under the term protected field since it can play the same role within the sequence.

The monitoring processes of the two sensors preferably overlap one another at least in the fourth protected field C so that a higher safety level is reached here. If, for example, every sensor is per se only designed according to PLc, even PLd can be reached in protected field C. The overlap and thus the higher safety level can extend to further protected fields.

The first protected field W is preferably monitored as a functional first protected field α, the second protected field A without the third protected field B as a second functional protected field β, the third protected field B without the fourth protected field C as a functional third protected field γ, an overlap zone of the third protected field B with the fourth protected field C as a functional fourth protected field δ, the fourth protected field C without the third protected field B as a functional fifth protected field ε, and the fifth protected field D without the fourth protected field C as a sixth protected field ζ. Functional protected field means that a protected field is monitored from the viewpoint of the safety application, but this protected field odes not directly have to correspond to a protected field defined for a sensor. The monitoring of a functional protected field rather takes place by a common evaluation of intrusions into the protected fields actually defined per sensor. In this respect, there are in particular overlap zones (“AND” condition to the protected field intrusions) and exclusive zones (“WITHOUT” or “AND NOT” condition to the protected field intrusions). More protected fields effectively become possible than the sum of the protected fields of the participating sensors due to such common evaluations and certain protected fields can moreover become redundant and can therefore be monitored at a higher safety level. The specifically indicated association combines the two configurations explained in the preceding paragraphs. Preferably, the functional fourth protected field δ for the cooperation zone and even more preferably also the adjacent functional third protected field γ and/or the adjacent fifth functional protected field & can thereby reach a higher safety level.

In the monitoring device in accordance with the invention, at least one optoelectronic sensor, preferably a safe optoelectronic sensor, is provided for a protected field monitoring that has a light receiver for generating a received signal from incident received light. Depending on the sensor, the received signal is, for example, the signal of a photodiode that receives a returning scan beam or image data of an image sensor are called a received signal in generalized terms. A control and evaluation unit is responsible for the protected field monitoring and the check of protected field intrusions for an unpermitted combination. The control and evaluation unit can be implemented in the sensor and/or in a processing unit connected thereto, in particular in a safety controller connected to the sensor. Safety controller means a safe evaluation unit that is implemented on any desired hardware, in particular a safety controller as a controller permitted for safety applications in a narrower sense. A particularly advantageous division of work provides a protected field monitoring internally in the sensor and an external evaluation of the protected field intrusions to recognize unpermitted combinations. One of the embodiments of the method in accordance with the invention is in particular implemented in the monitoring device.

The invention will be explained in more detail in the following also with respect to further features and advantages by way of example and with reference to embodiments and to the enclosed drawing. The Figures of the drawing show in:

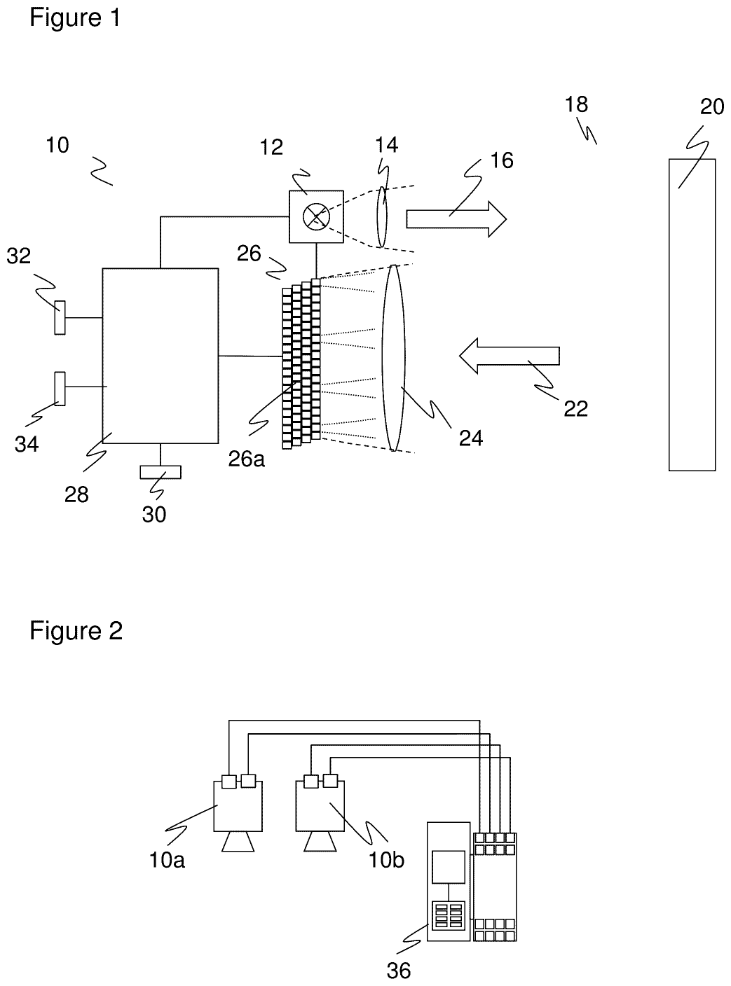

FIG. 1 a schematic block diagram of a 3D time of flight camera;

FIG. 2 a schematic representation of a monitoring device having two cameras and a safety controller;

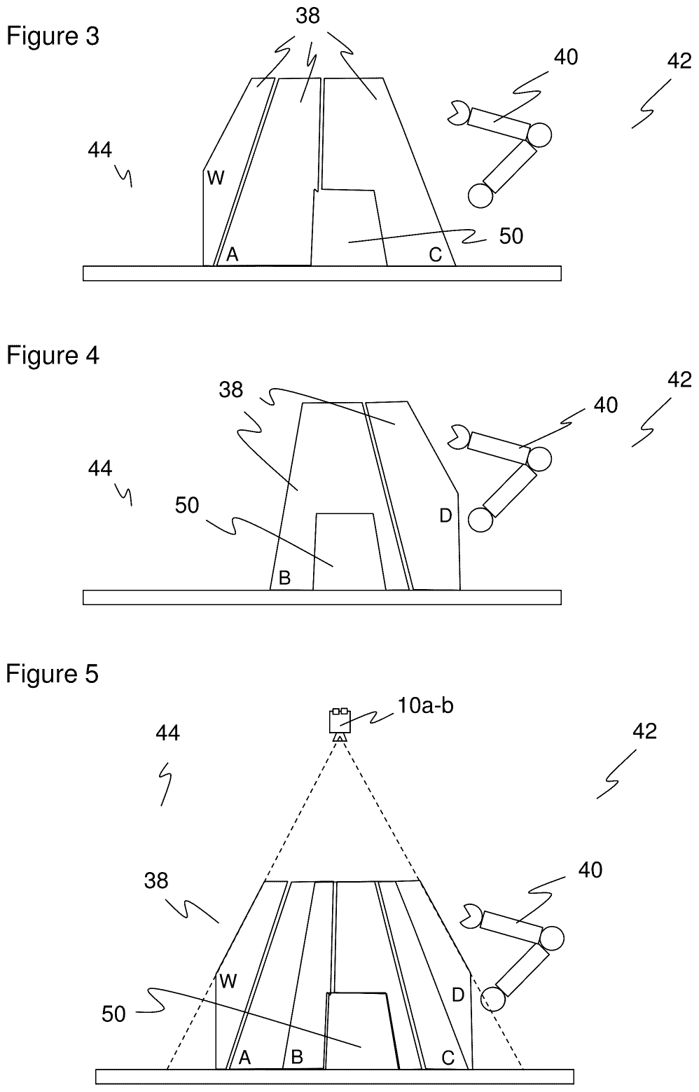

FIG. 3 a schematic representation of protected field configuration of a first camera;

FIG. 4 a schematic representation of a protected field configuration of a second camera;

FIG. 5 a schematic representation of the combined protected field configuration of both cameras in accordance with FIGS. 3 and 4;

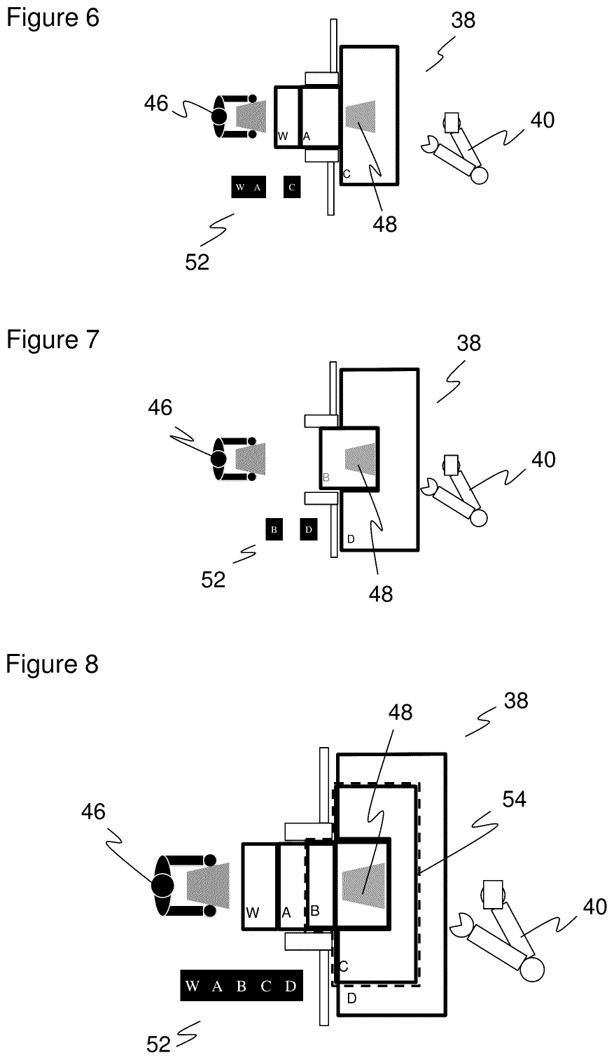

FIG. 6 an alternative representation of the protected field configuration of the first camera in accordance with FIG. 3 from a plan view;

FIG. 7 an alternative representation of the protected field configuration of the second camera in accordance with FIG. 4 from a plan view;

FIG. 8 an alternative representation of the combined protected field configuration of both cameras in accordance with FIG. 5 from a plan view;

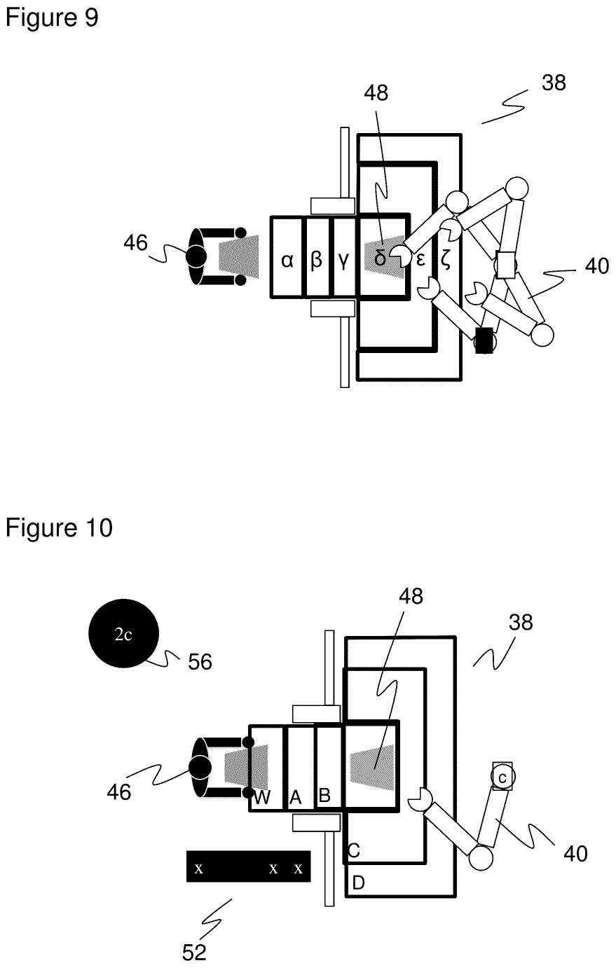

FIG. 9 a representation similar to FIG. 8 in which the protected fields actually monitored by the cameras are combined by a common evaluation to form more finely defined functional protected fields;

FIG. 10 a schematic representation of an exemplary approach situation of a worker still at a greater distance from the machine to be safeguarded that can simultaneously be understood as an exemplary state of a finite state machine;

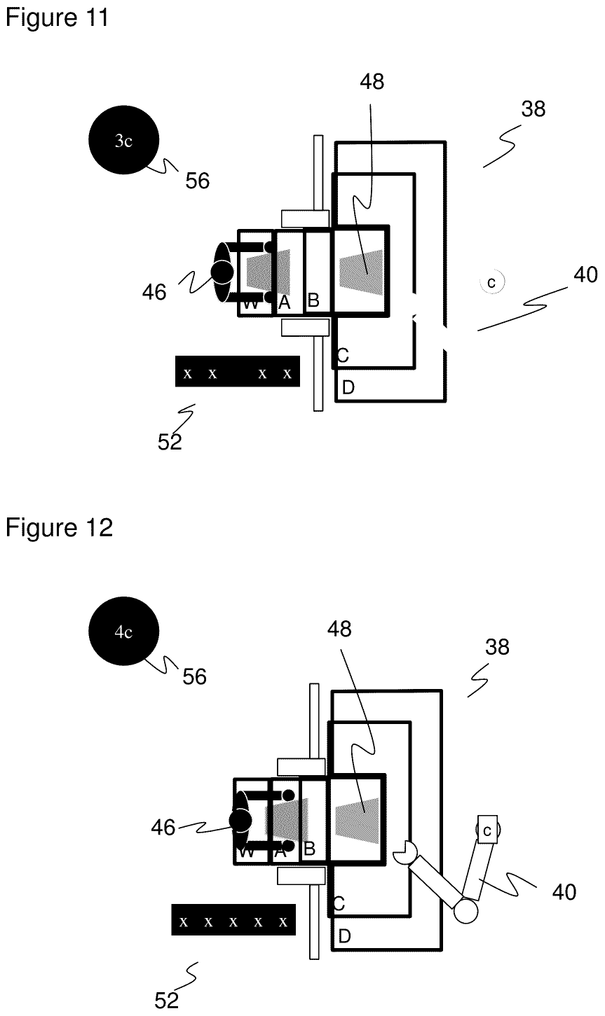

FIG. 11 a schematic representation of the approach situation of a worker now at a small distance from the machine to be safeguarded that can simultaneously be understood as a further exemplary state of the finite state machine;

FIG. 12 a schematic representation of the approach situation of a worker now completely without a defined distance from the machine to be safeguarded that can simultaneously be understood as a further exemplary state of the finite state machine; and

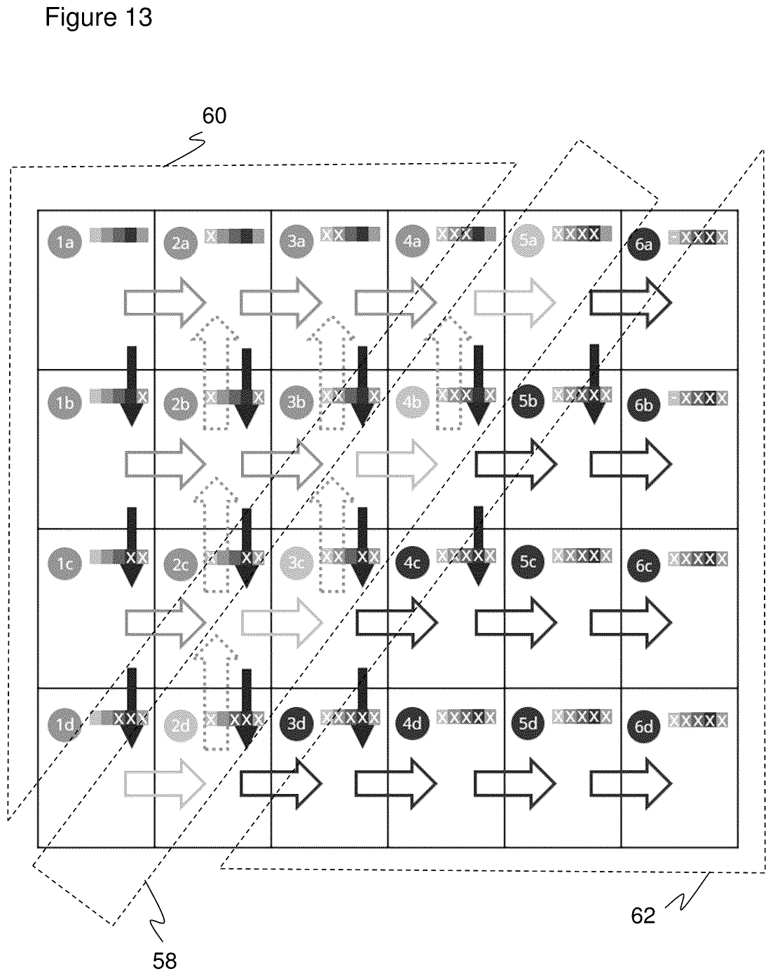

FIG. 13 an overview representation of the finite state machine from which three states are illustrated by way of example in FIGS. 10 to 12.

FIG. 1 shows a schematic block diagram of a camera 10 that is preferably configured as a 3D time of flight camera and that will be described as representative for an optoelectronic sensor that can be used in connection with the invention. An illumination unit 12 transmits transmitted light 16 modulated by a transmission optics 14 into a monitored zone 18. LEDs or lasers in the form of edge emitters or VSCELs can be considered as the light source. The illumination unit 12 is controllable such that the amplitude of the transmitted light 16 is modulated at a frequency typically in the range of 1 MHz to 1000 MHz The modulation is, for example, sinusoidal or rectangular, at least a periodic modulation. A limited unambiguity range of the distance measurement is produced by the frequency so that small modulation frequencies are required for large ranges of the camera 10. Alternatively, measurements are carried out at two to three or more modulation frequencies to increase the unambiguity range in a combination of measurements.

When the transmitted light 16 is incident on an object or a person 20 in the monitored zone 18, a portion of the received light 22 is reflected back to the camera 10 and is guided there through a reception optics 24, for example a single lens or a reception objective, onto an image sensor 26. The image sensor 26 has a plurality of reception elements or reception pixels 26a arranged to form a matrix or a row, for example. The resolution of the image sensor 26 can extend from two or some few up to thousands or millions of reception pixels 26a. A demodulation corresponding to a lock-in process takes place therein. A plurality of scan values from which ultimately the phase shift between the transmitted light 16 and the received light 22, and thus the time of flight, can be measured are generated by repeated detection with a modulation of the transmitted light 16 respectively slightly displaced over the repetitions. The pixel arrangement is typically a matrix so that a lateral spatial resolution results in an X direction and in a Y direction, which is supplemented by the Z direction of the distance measurement to form the three-dimensional image data. This 3D detection is preferably meant when a 3D camera, a 3D time of flight camera, or three-dimensional image data are spoken of. In principle, however, different pixel arrangements are also conceivable; for instance, a pixel row that is selected in a matrix or that forms the whole image sensor of a line scan camera.

A plurality of protected fields can be configured in a control and evaluation unit 28. A protected field is defined by geometrical specifications for a partial zone of the monitored zone 18 that are configured or are fed in via an interface 30, for example in a CAD program or in any other manner by means of the control and evaluation unit 28. The protected fields are monitored for object intrusions and, on a protected field intrusion, a safe output signal is output at a safe output 32, 34. A plurality of safe outputs 32, 34 are preferably provided per protected field or the output signal encodes the protected fields respectively impacted by intrusions at a single safe output. The camera 10 and in particular the protected field evaluation together with the output signals are preferably safe in the sense defined in the introduction.

The described 3D camera 10, in particular a TOF camera, is particularly suitable for the safeguarding in accordance with the invention. Other sensors are, however, also possible, in particular a safety laser scanner. Certain restrictions then possibly have to be accepted, for example by conditions on the application geometry.

FIG. 2 shows a schematic representation of a monitoring device having two cameras 10a-b, each connected to a safety controller 36. The combination of a plurality of cameras 10a-b is particularly advantageous; the invention can, however, also be implemented with only one camera 10a-b. Only an elevated safety level in protected fields monitored in an overlapping manner, which will be looked at later, is not achievable with only one camera 10a-b. The safety controller 36 permits a higher ranking evaluation of the protected field intrusions that are reported by the individual cameras 10a-b. If a hazard is recognized here, a safety related signal is output to a monitored machine or to a robot. The machine or robot thereupon becomes slower or diverges to worksteps that can at least not be a hazard with this recognized object movement and the machine is only switched to a safe state in case of an emergency. High availability and productivity are thus achieved overall. The specific monitoring in accordance with the invention will be explained in more detail in the following with reference to FIGS. 3 to 13.

The distribution of the evaluation over internal and external control and evaluation units 28 of the cameras 10a-b for recognizing protected field intrusions and for a higher ranking evaluation of the protected field intrusions in the safety controller 36 is particularly advantageous. A very simple logic, for example in the form of a finite state machine that does not make any high hardware demands, is sufficient in the safety controller. The invention is, however, not restricted to a specific association of the evaluation functionality to specific hardware modules, but can rather be distributed as desired over external and internal, including the extreme cases in which no separate evaluation at all takes place in the cameras 10a-b, or conversely at least one of the cameras 10a-b integrates the functionality of the safety controller. Examples for an internal processing unit are digital processing modules such as a microprocessor or a CPU (central processing unit), an FPGA (field programmable gate array), a DSP (digital signal processor), an ASIC (application specific integrated circuit), an Al processor, an NPU (neural processing unit), a GPU (graphics processing unit), a VPU (video processing unit), or the like. An external processing unit can, in addition to the already mentioned safety controller 36, be a computer of any desired kind, including notebooks, smartphones or tablets, equally a local network, an edge device, or a cloud.

FIGS. 3 and 4 show a schematic representation of an exemplary configuration of protected fields 38 for safeguarding a machine 40, shown as a robot by way of representation, of the first camera 10a or of the second camera 10b. FIG. 5 is an associated combined view of the superposed protected field configuration of both cameras 10a-b. FIGS. 6 and 7 show the individual protected field configurations of FIGS. 3 and 4 again alternatively from a plan view, correspondingly FIG. 8 shows the combined protected field configuration of FIG. 5 in a plan view.

The protected fields 38 are shown in section in FIGS. 3 to 5 and have an additional depth extent that can be seen from the plan view of FIGS. 6 to 8. They are therefore spatial three-dimensional protected fields. The machine 40 is located in a mechanically safeguarded working zone 42, for example in a robot cell, inaccessible to persons. A worker 46, only shown in FIGS. 6 to 8, can enter a cooperation zone 48 via an access zone 44 safeguarded by the protected fields 38 to there, for example, to feed a workpiece or material to the machine 40 or to accept it.

The first camera 10a monitors three protected fields W, A, C that are arranged in a row in a connection direction between the machine 40 and the approaching worker 46. The protected field W may only be a warning field that therefore like a protected field recognizes object intrusions and permits corresponding responses, that is does not have any actual safety function unlike a protected field. In the example shown, the robot cannot even physically reach the warning field W so that no protective function is required here. The second camera 10b correspondingly monitors two consecutive protected fields B and D. The geometry of the protected fields 38 is somewhat more complex to adapt to the spatial circumstances, for instance with a cutout 50 in the environment of the cooperation zone 48. A common protected field sequence W, A, B, C, D is produced in the combined protected field monitoring. This sequence and the contribution of the individual cameras 10a-b can be understood again in a symbolic overview 52 of FIGS. 6 to 8 only added for explanation.

The protected fields W, A, B, C, D are simultaneously active. There are zones here in which protected fields are superposed on one another and in which a higher safety level can therefore be reached. Such a zone is characterized by a dashed line 54 in FIG. 8. A protected field monitoring with safety level PLd is implemented, for example, by superposition with two cameras 10a-b of safety level PLc. The protected fields form a first sequence at the worker side and a second sequence at the machine side. On an approach of the worker 46, a sequence WABCD is expected; conversely on an approach of the machine 40, a sequence DCBAW is expected, with a respective overlap beyond the cooperation zone 48 not being permitted and with the machine 40, for example, not being able to reach protected field W at all. The safety controller 36 checks such conditions on the combination of the present protected field infringements that will presently be refined. It allows the machine 40 to continue work undiminished as long as the combination of the protected field intrusions is not critical at all, provides instructions to a machine controller of the machine 40 in somewhat more critical situations to anticipate a real hazardous situation by prohibitions of certain movements or by a withdrawal of the machine 40, or triggers a safeguarding of the machine 40 where necessary.

FIG. 9 shows a representation similar to FIG. 8 in which the protected fields 38 actually monitored by the cameras 10a-b are combined by a common evaluation to form more finely defined functional protected fields. A functional protected field can equally be understood as a protected field; only its evaluation for protected field infringements is possibly only possible in combination of both cameras 10a-b by overlap conditions (“AND”) or exclusivity conditions (“WITHOUT”), with such conditions also being able to be linked. According to this principle, the six functional protected fields of FIG. 9 or even more functional protected fields can be generated. No further difference is made between protected fields and functional protected fields for the invention, apart from the fact that the maximum number of simultaneously monitorable protected fields of the camera 10a-b is made possible beyond their actual specification due to functional protected fields. In contrast, the original protected field intrusions WABCD are sufficient for the now following observations. FIG. 9 specifically shows by way of example a first functional protected field α corresponding to the protected field W, a second functional protected field β corresponding to the protected field A WITHOUT B, a third functional protected field γ corresponding to the protected field B WITHOUT C, a fourth functional protected field δ with the cooperation zone 48 as an overlap zone of the protected fields B AND C, a fifth functional protected field ε corresponding to the protected field C WITHOUT B, and a sixth functional protected field ζ corresponding to the protected field D WITHOUT C.

Whereas in FIG. 8 neither the machine 40 nor the worker intrude in any protected field 38 in an obviously non-critical manner, FIGS. 10 to 12 show an approach movement of the worker 46 in which, by way of example, the machine 40 already intrudes into the respective protected fields C and D from its side. The worker 46 has initially only intruded into the most extreme protected field W in the situation of FIG. 10. Since the machine 40 still observes a distance from the cooperation zone 48 at its side, the protected fields A and B are still free in the inner part of the common sequence that is assembled on both sides from the sequence at the worker side and at the machine side. This is also illustrated again in the symbolic overview 52 in which an “x” marks a projected field intrusion.

A minimum number of two free protected fields between the machine 40 and the worker 46 is considered uncritical; the machine 40 can continue to work at an unreduced speed. However, the machine controller preferably receives the instruction to leave protected field B free, that is not to approach it further or even to withdraw from protected field C as a precaution in preparation for an expected continued approach of the worker 46. The machine controller itself is preferably not safe since a safe machine controller means a high effort and should not be simply predetermined at least in a safety application. There is therefore by all means the possibility that the machine 40 nevertheless intrudes into protected field B or does not release protected field C contrary to an instruction that may have taken place. The safety controller 36 in turn considers this as unpermitted since it had prohibited the dwelling in the respective protected field and can correspondingly respond with further instructions to the machine 40 or, where required, with a further safeguarding of the machine 40.

In the situation of FIG. 11, the worker 46 has further approached and in this respect has also intruded in protected field A. The machine has not moved, it is to be assumed that it has not received any corresponding instruction to already release protected field C as a precaution. The buffer of free protected fields between the machine 40 and the worker 46 has shrunk to only a single protected field B. This minimum number of one free protected field does not mean any actual danger since the machine 40 and the worker 46 can still not come into contact and it is clear that both are located on their respective sides still separate from one another. However, a critical situation can now occur very quickly. The worker 46 therefore receives a warning, for example in the form of a now yellow light and no longer a green illuminated light as before. The machine receives the instruction to withdraw from protected field C. The warning to the worker 46 should tell him to give the machine 40 the time required for the withdrawal.

In the situation of FIG. 12, the worker 46 has further approached and now also intrudes in protected field B. The machine 40 has, however, not yet released protected field C, either because the worker 46 has entered too fast or because the machine controller has not followed the instruction. An intrusion in all the protected fields is therefore now present, there is no longer any buffer of free protected fields between the machine 40 and the worker 46. This is admittedly not yet dangerous at all in the situation of FIG. 12 shown. The safety controller 36 can, however, no longer distinguish this; due to the lack of a buffer at free protected fields, the machine 40 and the worker 46 are at least potentially at the same location in their rough spatial resolution provided by the protected fields. The machine 40 is therefore safeguarded.

The machine 40 can now possibly withdraw from protected field C and then also from protected field D in a creep mode harmless to persons. The worker 46 can equally move back either immediately or after its worksteps in the cooperation zone 48 have ended. A buffer of a minimum number of two free protected fields can now again be established between the machine 40 and the worker 46. In this situation or, as a precaution, the machine 40 can only restart when an even larger buffer has been produced or a protected field intrusion is no longer present. This is done manually, for example, by actuating a button that the worker 46 can only reach from the outside and after he has made sure that the working zone 42 is free. An automatic restart without a button or the like is preferably possible as soon as said condition on the buffer has been satisfied again. An additional trespass protection, for instance by means of radar or a further camera, is possibly required depending on the geometrical conditions and the specific protected field geometry and arrangement. This should prevent the worker 46 or a further person from moving into the working zone 42 while all the protected fields are anyway still infringed and the monitoring device is therefore effectively blind for this entry.

The given minimum numbers for buffers of free protected fields are particularly advantageous; however, this can be deviated from, that is a higher minimum number can be required, in particular when longer sequences of more protected fields have been formed to, for example, form very fine-grain sequences.

FIG. 13 shows an overview representation of a finite state machine by which the suitable measure can be associated with the possible combinations of protected field intrusions from which three states are illustrated by way of example in FIGS. 10 to 12. The states are ordered in the columns 1 to 6 with an increasing approach of the worker 46 and in the rows with an increasing approach of the machine 40 to the cooperation zone 48. Possible states 1a . . . 6a, 1b . . . 6d thereby result. Three of these states, namely 2c, 3c, and 4c have already been explained by way of example with reference to FIGS. 10 and 12 and are correspondingly marked by a symbol 56.

The protected fields in which an intrusion has taken place are respectively marked by “x” in the states shown in a table. Three regions of the states can be distinguished, namely a minor diagonal 58 from the states 2d, 3c, 4b, and 5a, a first triangle 50 to the left above, and a second triangle 62 to the right below it. There are at least two free protected fields between the machine 40 and the worker 46 in the states within the first triangle 60 so that the machine 40 can continue to work in an unreduced manner. This has been described with reference to FIG. 10. In the states on the minor diagonal 58, there is only one free protected field as a buffer between the machine 40 and the worker 46 so that the worker 46 receives a warning so that the machine 40 can withdraw, as described with reference to FIG. 11. In the states in the second triangle 62, there is no buffer at all between the machine 40 and the worker 46 and the machine is therefore safeguarded as explained with reference to FIG. 12.

The most important measure with respect to the states has thus already been named, namely whether safeguarding has to take place as within the second triangle 62, whether a warning should be given as on the minor diagonal 58, or whether the machine 40 can continue to work as within the first triangle 60. The vertical arrows in FIG. 13 symbolize further possible measures. Downward arrows stand for an approach to the cooperation zone 48 allowed and safeguarded to the machine 40. Dashed upward arrows signify the explained preferably withdrawal movement of the machine 40 on an approach of the worker 46. The withdrawal of the machine 40 or a corresponding entry prohibition relates to a respective protected field that is associated with the protected field that the worker 46 now enters. It is here a question of reestablishing the buffer of two free protected fields or of expanding the buffer to prepare for a further approach of the worker 46. The horizontal arrows do not symbolize any measures, but rather actions of the worker 46, namely his approach movement. As already mentioned, approach movements of the worker 46 are uncritical for states within the first triangle 60. With states of the minor diagonals 58, a further approach could trigger a safeguarding, for states in the second triangle 62, the safeguarding is triggered.

1. A method for contactless safeguarding at a cooperation zone of a machine, wherein an access zone for a worker is arranged at a first side of the cooperation zone and a working zone of the machine is arranged at a second side different from the first side, wherein a plurality of protected fields configured in the environment of the cooperation zone are monitored for protected field intrusions by at least one optoelectronic sensor and at least two of the protected fields are arranged in a first sequence starting from the first side such that a worker sequentially intrudes into these protected fields when approaching the cooperation zone, wherein the protected field intrusions are evaluated to safeguard the machine in the case of an unpermitted combination of protected field intrusions, and
wherein at least two of the protected fields are arranged in a second sequence starting from the second side such that the machine sequentially intrudes in these protected fields when approaching the cooperation zone.

2. The method in accordance with claim 1,
wherein the machine comprises at least one robot.

3. The method in accordance with claim 1,
wherein the optoelectronic sensor is a 3D sensor; and wherein the protected fields are three-dimensional protected fields.

4. The method in accordance with claim 3,
wherein the optoelectronic sensor is a time of flight camera.

5. The method in accordance with claim 1,
wherein at least two optoelectronic sensors each monitor some of the protected fields; and wherein at least one protected field is monitored by both optoelectronic sensors and is therefore monitored at an elevated safety level.

6. The method in accordance with claim 5,
wherein one protected field comprises the cooperation zone and this protected field is monitored by both optoelectronic sensors.

7. The method in accordance with claim 1,
wherein it is considered a permitted combination of protected field intrusions when protected fields of the first sequence and/or of the second sequence are infringed sequentially from the outside to the inside, with inside designating the cooperation zone, but with a minimum number of protected fields without a protected field intrusion remaining between protected fields of the two sequences here.

8. The method in accordance with claim 7,
wherein, when a protected field of the first sequence is infringed, the machine may no longer intrude into a protected field associated with the first sequence corresponding to the minimum number and the machine retreats therefrom provided that it already intrudes into the associated protected field.

9. The method in accordance with claim 7,
wherein the machine continues to work without any restriction of its work speed on observing a minimum number of two.

10. The method in accordance with claim 7,
wherein the worker receives a warning not to further approach the cooperation zone on observing only a minimum number of one.

11. The method in accordance with claim 7,
wherein the machine is safeguarded when a minimum number has not been observed.

12. The method in accordance with claim 7,
wherein the machine restarts automatically as soon as the minimum number has been reestablished or a protected field is no longer infringed.

13. The method in accordance with claim 1,
wherein, for the evaluation of the protected field intrusions and the measures therefore to be taken with respect to the machine, a finite state machine is used whose transitions are determined by an additional intrusion into a protected field of a sequence or the ending of an intrusion into the protected field of a sequence is determined; and wherein the measures are a moving of the machine away from the cooperation zone in the second direction, a prohibition of intrusions into a protected field by the machine, and/or the canceling of a prohibition of intrusions into a protected field.

14. The method in accordance with claim 1,
wherein the first sequence comprises, from the outside to the inside with respect to the cooperation zone, a first protected field α, a second protected field β, and a third protected field γ, the cooperation zone is monitored by a fourth protected field δ and the second sequence, starting from the inside to the outside of the cooperation zone, comprises a fifth protected field ε and a sixth protected field ζ.

15. The method in accordance with claim 1,
wherein two optoelectronic sensors monitor five protected fields W, A, B, C, D, namely the one optoelectronic sensor in the access zone monitors an outer first protected field W, a second protected field A enclosing the zone between the first protected field W and the cooperation zone, and a fourth protected field C adjoining in the working zone and comprising the cooperation zone and the other optoelectronic sensor in the working zone monitors an outer fifth protected field D and a third protected field B comprising the cooperation zone and projecting into the access zone.

16. The method in accordance with claim 15,
wherein the monitoring processes of the two sensors overlap at least in the fourth protected field C so that a higher safety level is reached here.

17. The method in accordance with claim 15,
wherein the first protected field W is monitored as a functional first protected field α, the second protected field A without the third protected field B as a second functional protected field β, the third protected field B without the fourth protected field C as a functional third protected field γ, an overlap zone of the third protected field B with the fourth protected field C as a functional fourth protected field γ, the fourth protected field C without the third protected field B as a functional fifth protected field ε, and the fifth protected field D without the fourth protected field C as a sixth protected field ζ.

18. A monitoring device for contactless safeguarding at a cooperation zone of a machine, wherein an access zone for a worker is arranged at a first side of the cooperation zone and a working zone of the machine is arranged at a second side different from the first side, wherein the monitoring device has at least one safe optoelectronic sensor having a light receiver for generating a received signal and has a control and evaluation unit that is configured to monitor a plurality of protected fields configured in the environment of the cooperation zone for protected field intrusions with reference to the received signal, wherein the protected fields are configured such that at least two of the protected fields are arranged in a first sequence starting from the first side such that a worker sequentially intrudes into these protected fields when approaching the cooperation zone, and wherein the control and evaluation unit is configured to evaluate the protected field intrusions to safeguard the machine in the case of an unpermitted combination of protected field intrusions, and
wherein the protected fields are configured such that at least two of the protected fields are arranged in a second sequence starting from the second side such that the machine sequentially intrudes in these protected fields when approaching the cooperation zone.

19. The monitoring device in accordance with claim 18, wherein the machine comprises at least one robot.

20. The monitoring device in accordance with claim 18, wherein the safe optoelectronic sensor is a 3D camera.
